(19) United States
(12) Patent Application Publication
(10) Pub. No.: US 2015/0357635 A1
(43) Pub. Date: Dec. 10, 2015

(54) FLAT NONAQUEOUS ELECTROLYTE SECONDARY BATTERY AND BATTERY PACK

(71) Applicant: SANYO ELECTRIC CO., LTD., Daito-shi, Osaka (JP)

(72) Inventors: Daizo Jito, Osaka (JP); Takeshi Ogasawara, Hyogo (JP); Akihiro Kawakita, Hyogo (JP)

(73) Assignee: SANYO ELECTRIC CO., LTD., Daito-shi, Osaka (JP)

(21) Appl. No.: 14/760,298

(22) PCT Filed: Jan. 27, 2014
(86) PCT No.: PCT/JP2014/000394

§ 371 Date: Jul. 10, 2015

(30) Foreign Application Priority Data
Jan. 31, 2013 (JP) 2013-017568
Sep. 30, 2013 (JP) 2013-203343

(51) Int. Cl. H01M 4/36; H01M 10/0525; H01M 4/58

(52) U.S. Cl. CPC H01M 4/366; H01M 4/5825; H01M 10/0525; H01M 2220/30; H01M 2220/20

(57) ABSTRACT

A flat nonaqueous electrolyte secondary battery according to an aspect of the present invention having good charge/discharge cycles can be achieved even if the charge voltage of a positive electrode is high. A flat nonaqueous electrolyte secondary battery according to an aspect of the present invention includes a positive electrode plate in which a positive electrode mix layer containing a positive electrode active material capable of reversibly storing and releasing lithium is formed, a negative electrode plate, an electrode assembly having a structure in which the positive electrode plate and the negative electrode plate are stacked with a separator therebetween, and a nonaqueous electrolyte solution. A compound of at least one metal selected from Al, Mg, Ti, Zr, W, and rare-earth elements is attached to the surface of the positive electrode active material. A pressure is applied to the flat nonaqueous electrolyte secondary battery from outside.

### TECHNICAL FIELD

The present invention relates to a flat nonaqueous electrolyte secondary battery with longer life and a battery pack including the same.

### BACKGROUND ART

In recent years, smaller and lighter mobile data terminals such as mobile phones, notebook personal computers, and smartphones have been increasingly used and secondary batteries used as driving power supplies therefor have been required to have higher capacity. Nonaqueous electrolyte secondary batteries, which are charged and discharged in such a manner that lithium ions move between positive and negative electrodes during charge and discharge, have high energy density and high capacity and therefore are widely used as driving power supplies for the above mobile data terminals.

Furthermore, the nonaqueous electrolyte secondary batteries are recently attracting attention as power supplies for power for electric tools, electric vehicles (EVs), hybrid electric vehicles (HEVs and PHEVs), and the like and applications thereof are expected to be further expanded. Such power supplies for power need to have high capacity so as to be used for a long time or enhanced output characteristics in the case of repeating large-current charge and discharge in a relatively short time. In particular, in applications for electric tools, EVs, HEVs, and PHEVs, it is essential that output characteristics during large-current charge/discharge are maintained and high capacity is achieved.

In order to increase the capacity of a nonaqueous electrolyte secondary battery, it is conceivable to take such a method that the amount of Ni in a positive electrode active material is increased or the charge voltage is increased. In particular, in the case of increasing the charge voltage to a potential higher than 4.2 V on a lithium metal basis widely used in automobile applications, an attempt to improve storage properties at high temperature is necessary.

For example, Patent Literature 1 suggests that the presence of a group 3 element on the surface of particles of a positive electrode active material matrix can suppress the deterioration of charge storage properties due to the decomposition reaction of an electrolyte solution that occurs at the interface between the electrolyte solution and a positive electrode active material when the charge voltage is increased.

Furthermore, Patent Literature 2 discloses that in a battery for automobiles, an insulating particle layer composed of an alumina layer is placed on a surface of a negative electrode and the confining pressure of the battery ranges from 4 kgf/cm² (0.39 MPa) to 50 kgf/cm² (4.91 MPa), whereby the reduction of power during cycles can be suppressed in the case of placing the insulating particle layer on the negative electrode surface.

### CITATION LIST

### Patent Literature

PTL 1: WO 2005/008812

PTL 2: Japanese Published Unexamined Patent Application No. 2010-113966

### SUMMARY OF INVENTION

### Technical Problem

According to a positive electrode active material disclosed in Patent Literature 1, acceptably good charge storage properties can be achieved even if the charge voltage of a positive electrode is high. Furthermore, according to a lithium secondary battery disclosed in Patent Literature 2, acceptably good cycle characteristics can be achieved even though the insulating particle layer is placed on the negative electrode surface. However, in nonaqueous electrolyte secondary batteries disclosed in Patent Literatures 1 and 2, it has become clear that the reduction of charge/discharge cycle characteristics cannot be sufficiently suppressed when the charge voltage of the positive electrode is high.

In accordance with a flat nonaqueous electrolyte secondary battery according to an aspect of the present invention, good charge/discharge cycles can be achieved even if the charge voltage of a positive electrode is high.

### Solution to Problem

According to an aspect of the present invention, a flat nonaqueous electrolyte secondary battery includes a positive electrode plate in which a positive electrode mix layer containing a positive electrode active material capable of reversibly storing and releasing lithium is formed, a negative electrode plate in which a negative electrode mix layer containing a negative electrode active material capable of reversibly storing and releasing lithium is formed, an electrode assembly having a structure in which the positive electrode plate and the negative electrode plate are stacked with a separator therebetween, and a nonaqueous electrolyte solution. A compound of at least one metal selected from Al, Mg, Ti, Zr, W, and rare-earth elements is attached to the surface of the positive electrode active material. A pressure is applied to the flat nonaqueous electrolyte secondary battery from outside in a direction in which the positive electrode plate, the negative electrode plate, and the separator are stacked.

Furthermore, according to another aspect of the present invention, a battery pack in which a plurality of flat nonaqueous electrolyte secondary batteries are connected in series, parallel, or series-parallel, the battery pack includes a positive electrode plate in which a positive electrode mix layer containing a positive electrode active material capable of reversibly storing and releasing lithium is formed, a negative electrode plate in which a negative electrode mix layer containing a negative electrode active material capable of reversibly storing and releasing lithium is formed, an electrode assembly having a structure in which the positive electrode plate and the negative electrode plate are stacked with a separator therebetween, and a nonaqueous electrolyte solution. A compound of at least one metal selected from Al, Mg, Ti, Zr, W, and rare-earth elements is attached to the surface of the positive electrode active material. The flat nonaqueous electrolyte secondary batteries, which make up the battery pack, are arranged in a direction in which the positive electrode, the negative electrode, and the separator are stacked. The flat nonaqueous electrolyte secondary batteries are constrained to each other in the arrangement direction. A confining pressure is applied to the flat nonaqueous electrolyte secondary batteries from outside in the direction in which the positive electrode, the negative electrode, and the separator are stacked.

### Advantageous Effects of Invention

In accordance with a flat nonaqueous electrolyte secondary battery according to an aspect of the present invention and a battery pack according to another aspect thereof, charge/discharge cycle characteristics are good even if the charge voltage of a positive electrode exceeds 4.2 V on a lithium metal basis.

### BRIEF DESCRIPTION OF DRAWINGS

FIG. 1 is a perspective view of a flat roll.

FIG. 2A is a schematic front view of a laminate-type nonaqueous electrolyte secondary battery and

FIG. 2B is a sectional view taken along the line IIB-IIB of FIG. 2A.

FIG. 3A is a schematic view of a secondary particle portion of a positive electrode active material used in Experiment Example 4 before charge and FIG. 3B is also a schematic view thereof after charge.

### DESCRIPTION OF EMBODIMENTS

A flat nonaqueous electrolyte secondary battery according to an aspect of the present invention and a battery pack according to another aspect thereof are described below in detail using various experiment examples. However, the experiment examples below are exemplified in order to describe examples of the flat nonaqueous electrolyte secondary battery and the battery pack for the purpose of embodying the technical spirit of the present invention. It is not intended to limit the present invention to any of these experiment examples. The present invention is equally applicable to various modifications of those shown in these experiment examples without departing from the technical spirit of the claims.

### First Experiment Example

### Experiment Example 1

First, the configuration of a flat nonaqueous electrolyte secondary battery of Experiment Example 1 is described.

(Preparation of Positive Electrode Plate)

Lithium carbonate Li₂CO₃ and a nickel-cobalt-manganese composite hydroxide, represented by Ni_{0.35}Co_{0.35}Mn_{0.30}(OH)₂, obtained by coprecipitation were mixed together in an Ishikawa-type Raikai mortar such that the molar ratio of Li to all transition metals was 1.10:1. Next, the mixture was heat-treated at 1,000° C. for 20 hours in an air atmosphere and was then crushed, whereby a lithium-nickel-cobalt-manganese composite oxide, represented by Li_{1.10}Ni_{0.35}CO_{0.35}Nn_{0.30}O₂, having an average secondary particle size of about 15 μm was obtained.

Prepared were 1,000 g of particles of the lithium-nickel-cobalt-manganese composite oxide. The particles were added to 3.0 L of pure water, followed by stirring, whereby an emulsion in which the lithium-nickel-cobalt-manganese composite oxide was dispersed was prepared. Next, 350 mL of a solution prepared by dissolving 3.15 g of erbium nitrate pentahydrate (Er(NO₃)₃.5H₂O) in 200 mL of pure water was added to the emulsion. In this operation, in order to adjust the pH of the emulsion, in which the lithium-nickel-cobalt-manganese composite oxide was dispersed, to 9, 10% by mass of an aqueous solution of nitric acid or 10% by mass of an aqueous solution of sodium hydroxide was appropriately added thereto.

Next, after the addition of the erbium nitrate pentahydrate solution was completed, suction filtration was performed and water washing was further performed, whereby powder was obtained. The obtained powder was dried at 120° C., whereby erbium hydroxide attached to a portion of the surface of the lithium-nickel-cobalt-manganese composite oxide was obtained. Incidentally, observation by scanning electron microscopy (SEM) showed that the average particle size of erbium hydroxide was 10 nm. The amount of an attached erbium compound was 0.20% by mass with respect to the lithium-nickel-cobalt-manganese composite oxide in terms of an erbium element as measured by inductively coupled plasma (ICP) emission spectrometry. Thereafter, the obtained powder was heat-treated at 300° C. for 5 hours in air, whereby a positive electrode active material was prepared. The heat-treated erbium compound was mostly erbium oxyhydroxide.

The positive electrode active material obtained as described above, carbon black as a positive electrode conductive agent, and polyvinylidene fluoride (PVdF) as a binder were added to an adequate amount of N-methyl-2-pyrrolidone as a dispersion medium such that the mass ratio of the positive electrode active material to the positive electrode conductive agent to the binder was 92:5:3, followed by kneading, whereby positive electrode mix slurry was prepared. Thereafter, the positive electrode mix slurry was uniformly applied to both surfaces of a positive electrode current collector made of aluminium foil and was dried, followed by rolling with a rolling roller, whereby the packing density of positive electrode mix layers formed on both surfaces of the positive electrode current collector was adjusted to 2.6 g/cm³. Furthermore, a positive electrode current-collecting tab was attached thereto, whereby a positive electrode plate in which the positive electrode mix layers were formed on both surfaces of the positive electrode current collector was prepared.

(Preparation of Negative Electrode Plate)

Synthetic graphite as a negative electrode active material and SBR (styrene-butadiene rubber) as a binder were added to an aqueous solution prepared by dissolving CMC (carboxymethylcellulose sodium) which is a thickening agent in water such that the ratio of the negative electrode active material to the binder to the thickening agent was 98:1:1, followed by kneading, whereby negative electrode mix slurry was prepared. The negative electrode mix slurry was uniformly applied to both surfaces of a negative electrode current collector made of copper foil and was dried, followed by rolling with a rolling roller and the attachment of a negative electrode current-collecting tab, whereby a negative electrode plate in which negative electrode mix layers were formed on both surfaces of the positive electrode current collector was prepared.

(Preparation of Nonaqueous Electrolyte Solution)

Lithium hexafluorophosphate (LiPF₆) was dissolved in a mixed solvent prepared by mixing ethylene carbonate (EC), methyl ethyl carbonate (MEC), and dimethyl carbonate (DMC) at a volume ratio of 3:3:4 at 25° C. such that the concentration of lithium hexafluorophosphate was 1.2 moles/liter. Furthermore, 1% by mass of vinylene carbonate (VC) was added to and dissolved in an electrolyte solution, whereby a nonaqueous electrolyte solution was prepared.

(Preparation of Battery)

The single positive electrode plate, the single negative electrode plate, and two separators each including a polyethylene microporous membrane were used to prepare a flat roll. First, the positive electrode plate 16 and the negative electrode plate 17 were placed opposite to each other in such a state that the positive electrode plate 16 and the negative electrode plate 17 were insulated from each other with the separators 18 (refer to FIG. 2B). After the positive electrode plate 16, the negative electrode plate 17, and the separators 18 were spirally wound around a winding core with a cylindrical shape such that a positive electrode tab 11 and a negative electrode tab 12 were outermost, the winding core was pulled out, whereby a wound electrode assembly was prepared. The wound electrode assembly was squashed, whereby the flat roll 13 was obtained. The flat roll 13 has a structure in which the positive electrode plate 16 and the negative electrode plate 17 are stacked with the separators 18 therebetween.

The flat roll 13 prepared as described above and the above nonaqueous electrolyte solution were provided in an enclosure 14 made of an aluminium laminate in a glove box under an argon atmosphere, whereby a laminate-type nonaqueous electrolyte secondary battery 10 having a structure shown in FIGS. 2A and 2B, a thickness d of 3.6 mm, a width of 3.5 cm, and a length of 6.2 cm was prepared. The laminate-type nonaqueous electrolyte secondary battery 10 includes the positive electrode plate 16, the positive electrode tab 11, the negative electrode plate 17, the negative electrode tab 12, the enclosure 14 made of an aluminium laminate material, and a closed portion 15 formed by heat-sealing end portions of the aluminium laminate material. The nonaqueous electrolyte solution and the flat roll 13 are sealed in the enclosure 14 made of the aluminium laminate material.

Next, the laminate-type nonaqueous electrolyte secondary battery 10 was set such that a pressure (confining pressure) of 0.0883 MPa (0.9 kgf/cm²) was applied to the flat roll 13 in thickness d directions shown in FIG. 2B, that is, in directions (the directions of arrows in FIG. 2B) in which the positive electrode plate 16, the negative electrode plate 17, and the separators 18 were stacked, whereby the flat nonaqueous electrolyte secondary battery of Experiment Example 1 was obtained.

### Experiment Example 2

A flat nonaqueous electrolyte secondary battery of Experiment Example 2 was prepared in substantially the same manner as described in Experiment Example 1 except that no confining pressure was applied.

### Experiment Example 3

A flat nonaqueous electrolyte secondary battery of Experiment Example 3 was prepared in substantially the same manner as described in Experiment Example 1 except that a lithium-nickel-cobalt-manganese composite oxide, represented by Li_{1.10}Ni_{0.35}Co_{0.35}Mn_{0.30}O₂, having no erbium compound attached thereto was used as a positive electrode active material.

### Experiment Example 4

A flat nonaqueous electrolyte secondary battery of Experiment Example 4 was prepared in substantially the same manner as described in Experiment Example 1 except that a lithium-nickel-cobalt-manganese composite oxide, represented by Li_{1.10}Ni_{0.35}Co_{0.35}Mn_{0.30}O₂, having no erbium compound attached thereto was used as a positive electrode active material and no confining pressure was applied.

(Measurement of Capacity Retention)

The flat nonaqueous electrolyte secondary batteries of Experiment Examples 1 to 4 that were prepared as described above were repeatedly charged and discharged under conditions below and were measured for capacity retention after 150 cycles.

Charge Conditions in First Cycle

Constant-current charge was performed at a constant-current of 700 mA until the battery voltage reached 4.3 V (a positive electrode potential of 4.4 V on a lithium basis). After the battery voltage reached 4.3 V, constant-voltage charge was performed at a constant-voltage of 4.3 V until the current reached 35 mA.

Discharge Conditions in First Cycle

Constant-current discharge was performed at a constant-current of 700 mA until the battery voltage reached 3.0 V. The discharge capacity in this operation was measured and was defined as the initial discharge capacity.

Rest

The rest interval between the above charge and discharge was 10 minute.

Charge and discharge performed under the above conditions were defined as one cycle. The charge/discharge cycle was performed 150 times. The discharge capacity was measured in the 150th cycle and was defined as the discharge capacity after 150 cycles. The capacity retention after 150 cycles was calculated by a calculation equation below. The results were summarized in Table 1 below.

Capacity retention after 150 cycles(%)=(discharge capacity after 150 cycles/initial discharge capacity)×100

TABLE 1

| | Attached element | Confining | Capacity retention |
|---|---|---|---|
| Battery | species | pressure (MPa) | after 150 cycles (%) |
| Experiment | Er compound | 8.83 × 10⁻² | 91 |
| Example 1 | | | |
| Experiment | Er compound | 0 | 83 |
| Example 2 | | | |
| Experiment | None | 8.83 × 10⁻² | 83 |
| Example 3 | | | |
| Experiment | None | 0 | 80 |
| Example 4 | | | |

As is clear from the results in Table 1, the battery of Experiment Example 1 that has the erbium compound attached to a portion of the surface of the lithium-nickel-cobalt-manganese composite oxide and that is under a confining pressure of 8.83×10⁻² MPa (0.9 kgf/cm²) has more excellent cycle characteristics as compared to the batteries of Experiment Examples 2 to 4. In addition, in the battery of Experiment Example 2 that has the erbium compound attached to the positive electrode active material and that is under no confining pressure and the battery of Experiment Example 3 that is under confining pressure and that has no erbium compound, a certain improvement is observed with respect to the battery of Experiment Example 4 that has none of them. However, in the battery of Experiment Example 1 that has both of them, improvements far exceeding these individual effects are observed.

Reasons why such effects are obtained are probably as described below. That is, for the battery of Experiment Example 4 that is under no confining pressure and that has no attached compound, as shown in FIG. 3, since the decomposition reaction of a nonaqueous electrolyte solution occurs on the surface of secondary particles 21 of a positive electrode active material, deterioration starts from interfaces between primary particles located near the surface of secondary particles, deterioration that causes cracks 24 at junction interfaces between the primary particles occurs, cracks 23 are caused in the secondary particles 21 by the expansion and contraction of the positive electrode active material during charge/discharge cycles to cause the primary particles 22, and the decomposition reaction of the nonaqueous electrolyte solution is further promoted; hence, cycle characteristics are reduced.

For the battery of Experiment Example 2 that is under no confining pressure and that has the attached compound, the decomposition reaction of a nonaqueous electrolyte solution on the surface of secondary particles can be suppressed by the attached compound. However, the cracks 23 are caused in the secondary particles because a positive electrode active material expands and contracts due to the absence of confining pressure during charge/discharge cycles, the formation of primary particles cannot be prevented, and therefore the decomposition reaction of the electrolyte solution occurs from cracked portions; hence, cycle characteristics are reduced.

For the battery of Experiment Example 3 that is under confining pressure and that has no attached compound, the cracking of inner portions of secondary particles due to the expansion and contraction of the positive electrode active material can be suppressed by applying confining pressure. However, the decomposition reaction of a nonaqueous electrolyte solution occurs on the surface of the secondary particles because no attached compound is present and the surface deterioration of the secondary particles is caused. This deterioration starts particularly from junction interfaces between primary particles located near the surface of secondary particles of the positive electrode active material and causes the cracks 24 from the junction interfaces; hence, charge/discharge cycle characteristics are reduced.

In contrast, for the battery of Experiment Example 1 that is under confining pressure and that has the attached compound, both the decomposition reaction of the electrolyte solution on the surface of secondary particles and the cracking (inner portions of the secondary particles and junction interfaces between primary particles) of the positive electrode active material can be suppressed; hence, the effect of significantly improving cycle and characteristics is probably obtained.

### Second Experiment Example

### Experiment Example 5

A flat nonaqueous electrolyte secondary battery of Experiment Example 5 was prepared in substantially the same manner as described in Experiment Example 1 except that an attached compound was lanthanum hydroxide instead of erbium hydroxide.

A heat-treated lanthanum compound was mostly lanthanum hydroxide.

### Experiment Example 6

A flat nonaqueous electrolyte secondary battery of Experiment Example 6 was prepared in substantially the same manner as described in Experiment Example 1 except that an attached compound was neodymium hydroxide instead of erbium hydroxide.

A heat-treated neodymium compound was mostly lanthanum hydroxide.

### Experiment Example 7

A flat nonaqueous electrolyte secondary battery of Experiment Example 7 was prepared in substantially the same manner as described in Experiment Example 1 except that an attached compound was samarium hydroxide instead of erbium hydroxide.

A heat-treated samarium compound was mostly samarium oxyhydroxide.

The batteries of Experiment Examples 5 to 7 that were prepared as described above were subjected to a charge/discharge cycle test similarly to Experiment Examples 1 to 4, followed by the calculation of capacity retention after 150 cycles. The results were summarized in Table 2 below together with the results of Experiment Examples 1 and 3.

TABLE 2

| | Attached element | Confining | Capacity retention |
|---|---|---|---|
| Battery | species | pressure (MPa) | after 150 cycles (%) |
| Experiment | None | 8.83 × 10⁻² | 83 |
| Example 3 | | | |
| Experiment | Er compound | 8.83 × 10⁻² | 91 |
| Example 1 | | | |
| Experiment | La compound | 8.83 × 10⁻² | 91 |
| Example 5 | | | |
| Experiment | Nd compound | 8.83 × 10⁻² | 89 |
| Example 6 | | | |
| Experiment | Sm compound | 8.83 × 10⁻² | 89 |
| Example 7 | | | |

As is clear from the results in Table 2, the batteries of Experiment Examples 5 to 7 that have the lanthanum, neodymium, or samarium compound, other than an erbium compound, attached to a portion of the surface of a lithium-nickel-cobalt-manganese composite oxide and that are under a confining pressure of 8.83×10⁻² MPa (0.9 kgf/cm²) have more excellent cycle characteristics as compared to the battery of Experiment Example 3 that has none of these compounds. The batteries of Experiment Examples 5 to 7, as well as Experiment Example 1 in which the erbium compound is attached, exhibit high capacity retention. This suggests that an effect similar to that of the case where the erbium compound is attached is exhibited in the case where the lanthanum, neodymium, or samarium compound is attached. Rare-earth elements are known to have similar chemical properties. In addition, a similar effect is exhibited by four types of rare-earth elements including erbium. Therefore, a similar effect can be expected for other rare-earth elements.

### Third Experiment Example

### Experiment Example 8

A flat nonaqueous electrolyte secondary battery of Experiment Example 8 was prepared in substantially the same manner as described in Experiment Example 1 except that an attached compound was aluminium hydroxide instead of erbium hydroxide and was heat-treated at 400° C. Attached aluminium hydroxide was mostly converted into an oxide after heat treatment.

### Experiment Example 9

A flat nonaqueous electrolyte secondary battery of Experiment Example 9 was prepared in substantially the same manner as described in Experiment Example 1 except that an attached compound was magnesium hydroxide instead of erbium hydroxide and was heat-treated at 400° C. Attached magnesium hydroxide was mostly converted into an oxide after heat treatment.

### Experiment Example 10

A flat nonaqueous electrolyte secondary battery of Experiment Example 10 was prepared in substantially the same manner as described in Experiment Example 1 except that an attached compound was zirconium hydroxide instead of erbium hydroxide and was heat-treated at 400° C. Attached zirconium hydroxide was mostly converted into an oxide after heat treatment.

The batteries of Experiment Examples 8 to 10 that were prepared as described above were subjected to a charge/discharge cycle test similarly to Experiment Examples 1 to 4, followed by the calculation of capacity retention after 150 cycles. The results were summarized in Table 3 below together with the results of Experiment Examples 1 and 3.

TABLE 3

| | Attached element | Confining | Capacity retention |
|---|---|---|---|
| Battery | species | pressure (MPa) | after 150 cycles (%) |
| Experiment | None | 8.83 × 10⁻² | 83 |
| Example 3 | | | |
| Experiment | Er compound | 8.83 × 10⁻² | 91 |
| Example 1 | | | |
| Experiment | Al compound | 8.83 × 10⁻² | 88 |
| Example 8 | | | |
| Experiment | Mg compound | 8.83 × 10⁻² | 88 |
| Example 9 | | | |
| Experiment | Zr compound | 8.83 × 10⁻² | 89 |
| Example 10 | | | |

As is clear from the results in Table 3, the batteries of Experiment Examples 8 to 10 that have an aluminium, magnesium, or zirconium compound, other than an erbium compound, attached to a portion of the surface of a lithium-nickel-cobalt-manganese composite oxide and that are under a confining pressure of 8.83×10⁻² MPa (0.9 kgf/cm²) have more excellent cycle characteristics as compared to the battery of Experiment Example 3 that has none of these compounds. The batteries of Experiment Examples 8 to 10, as well as Experiment Example 1 in which the erbium compound is attached, exhibit high capacity retention and, however, exhibit lower capacity retention than Experiment Example 1. This suggests that the case where the erbium compound is attached is more preferable than the case where the aluminium, magnesium, or zirconium compound is attached.

### Fourth Experiment Example

### Experiment Example 11

After 4.8 g of ammonium zirconium carbonate (a 13% solution, in terms of ZrO₂) was mixed with 0.76 g of ammonium fluoride, distilled water was added, whereby 50 mL of a dilute coating solution was prepared. Next, 500 g of the lithium-nickel-cobalt-manganese composite oxide particles used in Experiment Example 1 were prepared. The coating solution was sprayed on the lithium-nickel-cobalt-manganese composite oxide particles.

Next, the lithium-nickel-cobalt-manganese composite oxide, on which the coating solution was sprayed, was dried at 120° C. for 2 hours. This allowed a positive electrode active material in which a compound containing zirconium and fluorine was attached to a portion of the surface of the lithium-nickel-cobalt-manganese composite oxide was obtained.

A flat nonaqueous electrolyte secondary battery of Experiment Example 11 was prepared in substantially the same manner as described in Experiment Example 1 except that the obtained positive electrode active material was used.

The battery of Experiment Example 11 that was prepared as described above was subjected to a charge/discharge cycle test similarly to Experiment Examples 1 to 4, followed by the calculation of capacity retention after 150 cycles. The results were summarized in Table 4 below together with the results of Experiment Examples 13 and 10.

TABLE 4

| | Attached element | Confining | Capacity retention |
|---|---|---|---|
| Battery | species | pressure (MPa) | after 150 cycles (%) |
| Experiment | None | 8.83 × 10⁻² | 83 |
| Example 3 | | | |
| Experiment | Er compound | 8.83 × 10⁻² | 91 |
| Example 1 | | | |
| Experiment | Zr compound | 8.83 × 10⁻² | 89 |
| Example 10 | (Oxide) | | |
| Experiment | Zr compound | 8.83 × 10⁻² | 90 |
| Example 11 | (fluorine-containing | | |
| | compound) | | |

As is clear from the results in Table 4, the battery of Experiment Example 11 that has the compound, containing zirconium and fluorine, attached to a portion of the surface of the lithium-nickel-cobalt-manganese composite oxide and that is under a confining pressure of 8.83×10⁻² MPa (0.9 kgf/cm²) has more excellent cycle characteristics as compared to the battery of Experiment Example 3 that has none of these compounds. The battery of Experiment Example 11, as well as Experiment Example 1 in which the erbium compound is attached and Experiment Example 10 in which the zirconium compound (oxide) is attached, exhibits high capacity retention. However, Experiment Example 11 in which a fluorine-containing compound is attached exhibits higher capacity retention than Experiment Example 10 in which an oxide is attached. This shows that the fluorine-containing compound is more preferable as an attached compound than the oxide.

A reason why such effects are obtained is probably because the fluorine-containing compound has the larger effect of suppressing the decomposition reaction of a nonaqueous electrolyte solution on the surface of secondary particles of the positive electrode active material as compared to the oxide. Thus, an effect similar to that of the case where a compound (fluorine-containing compound) of erbium, lanthanum, neodymium, samarium, aluminium, or magnesium is attached can be expected in the case where a zirconium compound (fluorine-containing compound) is attached.

### Fifth Experiment Example

### Experiment Example 12

A flat nonaqueous electrolyte secondary battery of Experiment Example 12 was prepared in substantially the same manner as described in Experiment Example 1 except that the confining pressure applied to the battery was 0.13 MPa instead of 0.0883 MPa (0.9 kgf/cm²).

### Experiment Example 13

A flat nonaqueous electrolyte secondary battery of Experiment Example 13 was prepared in substantially the same manner as described in Experiment Example 1 except that the confining pressure applied to the battery was 0.57 MPa instead of 0.0883 MPa (0.9 kgf/cm²).

### Experiment Example 14

A flat nonaqueous electrolyte secondary battery of Experiment Example 14 was prepared in substantially the same manner as described in Experiment Example 1 except that the confining pressure applied to the battery was 1.30 MPa instead of 0.0883 MPa (0.9 kgf/cm²).

The batteries of Experiment Examples 12 to 14 that were prepared as described above were subjected to a charge/discharge cycle test similarly to Experiment Examples 1 to 4, followed by the calculation of capacity retention after 150 cycles. The results were summarized in Table 5 below together with the results of Experiment Example 1.

TABLE 5

| | Attached element | Confining | Capacity retention |
|---|---|---|---|
| Battery | species | pressure (MPa) | after 150 cycles (%) |
| Experiment | Er compound | Not applied | 83 |
| Example 2 | | | |
| Experiment | Er compound | 0.0883 | 91 |
| Example 1 | | | |
| Experiment | Er compound | 0.1300 | 92 |
| Example 12 | | | |
| Experiment | Er compound | 0.5700 | 92 |
| Example 13 | | | |
| Experiment | Er compound | 1.3000 | 92 |
| Example 14 | | | |

As is clear from the results in Table 5, the batteries of Experiment Examples 12 to 14 that have an erbium compound attached to a portion of the surface of a lithium-nickel-cobalt-manganese composite oxide and that are under a confining pressure of 0.13 MPa, 0.57 MPa, or 1.30 MPa have more excellent cycle characteristics as compared to the battery of Experiment Example 2 that is under no confining pressure. The batteries of Experiment Examples 12 to 14, as well as Experiment Example 1 which is under a confining pressure of 0.0883 MPa, exhibit high capacity retention. This suggests that an effect similar to that of the case where the confining pressure is 0.0883 MPa is exhibited in the case where the confining pressure is 0.13 MPa, 0.57 MPa, or 1.30 MPa. The battery of Experiment Example 14 is under a confining pressure that is 10 times that applied to the battery of Experiment Example 12 and, however, exhibits the same capacity retention as that of the battery of Experiment Example 12. This is probably because the effect of suppressing the cracking of inner portions of secondary particles by the confining pressure is substantially saturated at 0.13 MPa. Thus, an effect similar to that of Experiment Examples 12 to 14 can be expected in the case where the confining pressure exceeds 1.30 MPa.

Incidentally, in Experiment Examples 1 and 5 to 14, the case where the confining pressure is 0.0883 MPa, 0.13 MPa, 0.57 MPa, or 1.30 MPa has been described. When the confining pressure is 9.81×10⁻² MPa (0.1 kgf/cm²) or more, a similar effect is achieved. When the confining pressure is less than 9.81×10⁻² MPa, cracks are likely to be caused in inner portions of secondary particles of the above-mentioned positive electrode active material and therefore cycle characteristics are reduced. Incidentally, there is no specific upper limit for the confining pressure from the viewpoint of suppressing the cracking of the inner portions of the secondary particles of the above-mentioned positive electrode active material. In consideration of the pressure resistance of a battery case and other battery members, the confining pressure is preferably 100 MPa or less. In particular, in the case where the positive electrode active material is pressurized at 100 MPa or more, cracks may possibly be caused from inner portions of secondary particles. Therefore, cracks are caused by the confining pressure and cycle characteristics may possibly be reduced. Hence, the confining pressure is preferably 100 MPa or less. In Experiment Examples 1 and 5 to 14, the case where a compound of a rare-earth element, an Al compound, an Mg compound, or a Zr compound is used as an attached compound has been described. The attached compound may be a compound of at least one metal selected from Al, Mg, Ti, Zr, W, and rare-earth elements. A combination of such a flat nonaqueous electrolyte secondary battery, the attached compound, and the confining pressure allows the deterioration of the positive electrode active material due to a reaction with a nonaqueous electrolyte solution on the surface of the positive electrode active material or at interfaces between particles of the positive electrode active material to be suppressed, leading to increases in cycle characteristics.

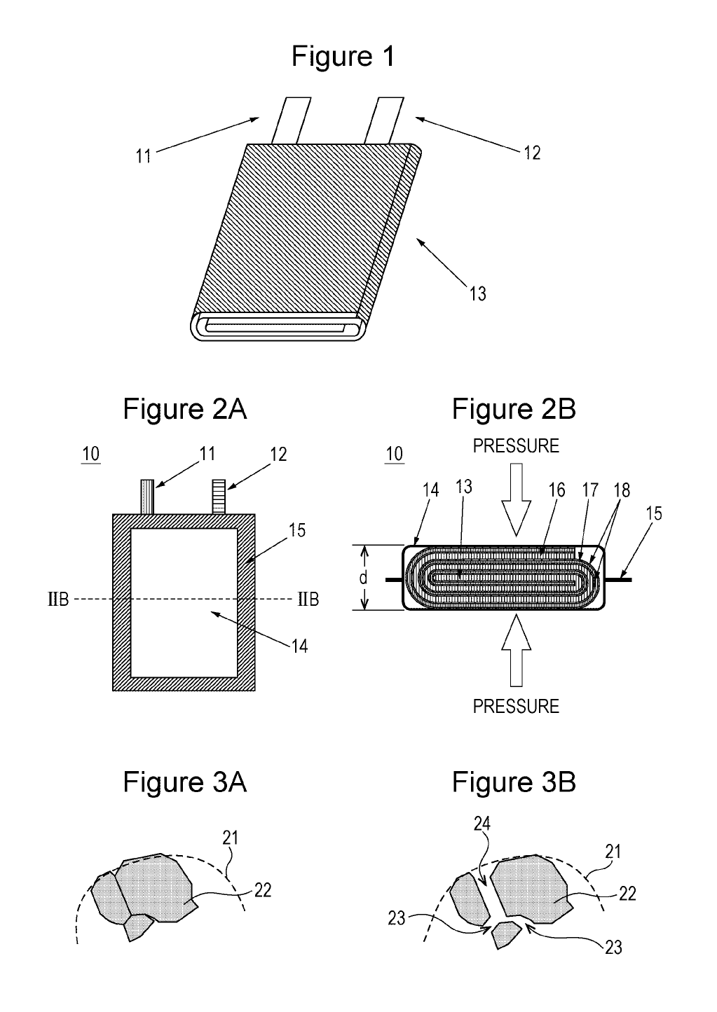

In Experiment Examples 1 and 5 to 14, the following example has been shown: an example using the flat roll 13 (refer to FIGS. 1 and 2B) that was prepared in such a manner that the positive electrode plate 16 and the negative electrode plate 17 were placed opposite to each other in such a state that the positive electrode plate 16 and the negative electrode plate 17 were insulated from each other with the separators 18 (refer to FIG. 2B) and the positive electrode plate 16, the negative electrode plate 17, and the separators 18 were then spirally wound, followed by squashing. However, in an aspect of the present invention, a similar action effect is achieved using a stack-type electrode assembly (not shown) prepared by stacking positive electrode plates and negative electrode plates in such a state that the positive and negative electrode plates are insulated from each other with a separator.

Furthermore, in Experiment Examples 1 and 5 to 14, the following example has been shown: an example using the aluminium laminate material as the enclosure 14 for housing the flat roll 13. An enclosure used in the present invention is one for use in conventional cells, is not particularly limited, and may be one in which the pressure applied from outside a flat nonaqueous electrolyte secondary battery is transmitted to a flat roll placed in an enclosure. For example, a metal can and an aluminium laminate can be cited as such an enclosure. In the present invention, even if a material for the enclosure or the thickness thereof is uneven, a target pressure can be applied to the flat roll by appropriately adjusting the pressure applied from outside the flat nonaqueous electrolyte secondary battery. In a battery pack, a target pressure can be applied to individual flat rolls by appropriately adjusting the confining pressure. In Experiment Examples 1 and 5 to 14, the aluminium laminate material is used as the enclosure 14 and the inner wall of the enclosure 14 and the flat roll 13 are arranged in close contact with each other as shown in FIG. 2B. According to this configuration, a pressure substantially equal to the pressure applied from outside the flat nonaqueous electrolyte secondary battery is probably transmitted to the flat roll 13 in the enclosure 14. Incidentally, in the case of using a rectangular metal can as an enclosure, when the inner wall of the enclosure and a flat roll are arranged in close contact with each other as with Experiment Examples 1 and 5 to 14, a pressure substantially equal to the pressure applied from outside a flat nonaqueous electrolyte secondary battery is probably transmitted to a flat roll placed in the enclosure.

Furthermore, in Experiment Examples 1 and 5 to 14, the following case has been described: the case where the compound attached to the positive electrode active material is the hydroxide, the oxide, the oxyhydroxide, or the fluorine-containing compound. The attached compound is preferably a compound of at least one metal selected from hydroxides, oxides, oxyhydroxides, carbonates, phosphates, and fluorine-containing compounds. In the case of using these compounds, a similar effect is achieved.

According to an aspect of the present invention, a positive electrode active material is preferably a positive electrode active material made of secondary particles formed by aggregating a positive electrode active material made of a plurality of primary particles. This is because a nonaqueous electrolyte solution permeates an inner portion and therefore output performance is higher than that of the case where a positive electrode active material is formed of primary particles only.

According to an aspect of the present invention, a compound attached to the positive electrode active material is preferably present on at least the surface of secondary particles. This is because deterioration on the surface of the secondary particles or at interfaces between primary particles is suppressed.

According to an aspect of the present invention, the compound attached to the positive electrode active material preferably contains a rare-earth element. This is because, in the case of a compound of the rare-earth element, the decomposition reaction of an electrolyte solution by the catalysis of a transition metal such as Co or Ni can be efficiently suppressed.

According to an aspect of the present invention, the compound attached to the positive electrode active material is preferably a hydroxide or oxyhydroxide of the rare-earth element.

Incidentally, cracking due to deterioration occurs from not only junction interfaces between primary particles located near the surface of secondary particles but also junction interfaces between grains in some cases depending on the type of the positive electrode active material used. In this case, cracking from the junction interfaces between the grains can be similarly suppressed by the use of a configuration of the present invention.

According to an aspect of the present invention, the packing density of a positive electrode mix is preferably 2.2 g/cm³ to 3.4 g/cm³. This is because when the packing density of the positive electrode mix is less than 2.2 g/cm³, the packing density is excessively low and therefore the resistance may possibly rise instead. This is because when the packing density is more than 3.4 g/cm³, secondary particles of aggregated primary particles are crushed into primary particles, the positive electrode active material that is not in contact with any conductive agent is likely to be isolated, and output may possibly decrease.

According to another aspect of the present invention, the following pack is provided: a battery pack in which a plurality of flat nonaqueous electrolyte secondary batteries which contain the above compound and which are connected in series, parallel, or series-parallel. The flat nonaqueous electrolyte secondary batteries, which make up the battery pack, are arranged in a direction in which a positive electrode, a negative electrode, and a separator are stacked. The flat nonaqueous electrolyte secondary batteries are constrained to each other in this arrangement direction. A confining pressure is applied to the flat nonaqueous electrolyte secondary batteries from outside in the direction in which the positive electrode, the negative electrode, and the separator are stacked. In this case, the confining pressure is preferably 9.81×10⁻³ MPa or more and more preferably 9.81×10⁻³ MPa to 100 MPa.

The following elements are exemplified as an element of a rare-earth compound as the compound attached to the positive electrode active material: yttrium, scandium, lanthanum, cerium, praseodymium, neodymium, samarium, europium, gadolinium, terbium, dysprosium, holmium, erbium, thulium, ytterbium, lutetium, and scandium. In particular, lanthanum, neodymium, samarium, and erbium are preferred. Furthermore, a plurality of elements can be used as rare-earth elements.

The total mass of the above elements in the total mass of particles of the positive electrode active material and the compound containing the above elements is preferably about 0.01% to 5% by mass and more preferably 0.02% to 1% by mass. When it is less than 0.01% by mass, the effect of improving cycle characteristics is low. When it is more than 5% by mass, discharge rate characteristics are low.

The following methods can be used as a method for attaching the compound containing the above elements to the surface of the positive electrode active material particles: for example, a method in which one in which at least one salt selected from the above group is dissolved in water is mixed with a solution in which a lithium-nickel-cobalt-manganese composite oxide is dispersed, a method in which the dissolved liquid is sprayed on the lithium-nickel-cobalt-manganese composite oxide, and the like.

One in which a hydroxide of a rare-earth element is attached to the surface of the lithium-nickel-cobalt-manganese composite oxide can be obtained in such a manner that, for example, one in which a sulfate or nitrate of the rare-earth element is dissolved in water is mixed with a solution in which the lithium-nickel-cobalt-manganese composite oxide is dispersed in water in several batches and the pH of the dispersion is maintained constant. The pH thereof is preferably controlled between 7 and 11 and particularly preferably 7 and 10. When the pH is less than 7, the active material is exposed to an acidic solution and therefore a portion of a transition metal may possibly be dissolved. When the pH is more than 10, the effect of suppressing side reactions between a nonaqueous electrolyte solution and the lithium-nickel-cobalt-manganese composite oxide is small because the rare-earth element attached to the surface of the active material is likely to segregate and the rare-earth element is not uniformly attached to the surface of the active material.

A hydroxide attached to the surface of the positive electrode active material is converted into another substance by heat treatment depending on the temperature thereof. The hydroxide is converted into an oxyhydroxide at about 200° C. to about 300° C. and is further converted into an oxide at about 400° C. to about 500° C.

A solution in which the rare-earth element or the like is dissolved can be obtained by a method in which a sulfate, acetate, or nitrate of the rare-earth element or the like is dissolved in water or by dissolving an oxide of the rare-earth element in nitric acid, sulfuric acid, acetic acid, or the like.

For example, a lithium transition metal composite oxide can be used as the positive electrode active material. In particular, Ni—Co—Mn-based lithium composite oxides and Ni—Co—Al-based lithium composite oxides have high capacity and high input-output characteristics and therefore are preferred. The following oxides are exemplified as other examples: lithium-cobalt composite oxides, Ni—Mn—Al-based lithium composite oxides, and olivine-type transition metal oxides (represented by LiMPO₄, where M is selected from Fe, Mn, Co, and Ni) containing iron, manganese, or the like. These may be used alone or in combination. Furthermore, a substance such as Al, Mg, Ti, or Zr may be contained in the lithium transition metal composite oxide in the form of a solid solution.

Those having a Ni-to-Co-to-Mn molar ratio of 1:1:1 or 5:3:2 or a known composition can be used as the Ni—Co—Mn-based lithium composite oxides. In particular, in order to allow the capacity of a positive electrode to be increased, one having a Ni or Co proportion greater than the proportion of Mn is preferably used and the difference in mole fraction between Ni and Mn is preferably 0.04% or more with respect to the sum of moles of Ni, Co, and Mn. In the case of using the same type or different types of positive electrode active materials, the positive electrode active materials may have the same particle size or different particle sizes.

A solvent conventionally used can be used as a solvent for a nonaqueous electrolyte. For example, the following compounds can be used: cyclic carbonates such as ethylene carbonate, propylene carbonate, butylene carbonate, and vinylene carbonate; linear carbonates such as dimethyl carbonate, methyl ethyl carbonate, and diethyl carbonate; compounds including esters such as methyl acetate, ethyl acetate, propyl acetate, methyl propionate, ethyl propionate, and γ-butyrolactone; compounds, such as propanesultone, containing a sulfo group; compounds including ethers such as 1,2-dimethoxyethane, 1,2-diethoxyethane, tetrahydrofuran, 1,3-dioxane, 1,4-dioxane, and 2-methyltetrahydrofuran; compounds including nitriles such as butyronitrile, valeronitrile, n-heptanenitrile, succinonitrile, glutaronitrile, adiponitrile, pimelonitrile, 1,2,3-propanetricarbonitrile, and 1,3,5-pentanetricarbonitrile; compounds including amides such as dimethylformamide; and the like. In particular, a solvent in which one or more of these hydrogen atoms are substituted by fluorine atoms is preferably used. These may be used alone or in combination. The following solvent is particularly preferred: a solvent which is a combination of a cyclic carbonate and a linear carbonate or a solvent which is a combination of these and small amounts of compounds including nitriles or compounds including ethers.

On the other hand, as a solute for a nonaqueous electrolyte, a solute conventionally used can be used and the following compounds and salts are exemplified: LiPF₆, LiBF₄, LiN(SO₂F)₂, LiN(SO₂CF₃)₂, LiN(SO₂C₂F₅)₂, LiPF₆₋ₓ (CₙF₂ₙ₋₁)ₓ (where 1<x<6 and n=1 or 2), lithium salts containing an oxalato complex anion, and salts such as LiPF₂O. As a lithium salt containing an oxalato complex anion, the following salts can be used: LiBOB (lithium bis(oxalate)borate) and lithium salts, containing an anion containing C₂O₄²⁻ coordinated to a central atom, represented by, for example, Li(M(C₂O₄)ₓR_{y}) (where M is an element selected from Group IIIb, Group IVb, and Group Vb in the periodic table; R is a group selected from a halogen, an alkyl group, and a halogen-substituted alkyl group; x is a positive integer; and y is 0 or a positive integer). In particular, there are Li(B(C₂O₄)F₂), Li(P(C₂O₄)F₄), Li(P(C₂O₄)₂F₂), and the like. However, in order to form a stable coating on a surface of the negative electrode in high-temperature environments, the use of LiBOB is most preferred. Incidentally, the solute may be used alone or two or more types of solutes may be used in combination. The concentration of the solute is not particularly limited and is preferably 0.8 moles to 1.7 moles per liter of an electrolyte solution.

A separator conventionally used can be used as the separator. In particular, the following separators may be used: a separator made of polyethylene, one including a polyethylene layer and a polypropylene layer formed on a surface thereof, and a polyethylene separator having a surface coated with resin such as an aramide-based resin.

A negative electrode conventionally used can be used as the negative electrode. In particular, a carbon material capable of storing and releasing lithium, a metal that can be alloyed with lithium, or an alloy compound containing the metal is cited. As the carbon material, graphite including natural graphite, non-graphitizable carbon, and synthetic graphite; coke; and the like can be used. As the alloy compound, those containing at least one metal that can be alloyed with lithium are cited. In particular, an element that can be alloyed with lithium is preferably silicon or tin and silicon oxide, tin oxide, and the like, in which these are bonded to oxygen, can be also used. Furthermore, a mixture of the carbon material and a compound of silicon or tin can be used. The surface of the carbon material or the alloy compound can be spotted or covered with another carbon material (amorphous carbon, low-crystallinity carbon, or the like) and a conductive material or the like can be also added. In addition, those having low energy density and higher charge/discharge potential with respect to metallic lithium of lithium titanate or the like as a negative electrode material as compared to the carbon material or the like can be used.

A silicon oxide (SiOₓ (0<x<2, particularly preferably 0<x<1)) may be used as a negative electrode active material in addition to the silicon and the silicon alloy. Thus, the silicon includes silicon in the silicon oxide represented by SiOₓ (0<x<2) (SiOₓ=(Si)_{1-1/2x}+(SiO₂)_{1/2x}).

A layer made of inorganic filler conventionally used can be formed at the interface between the positive electrode and the separator or the interface between the negative electrode and the separator. An oxide, conventionally used, containing one or more of titanium, aluminium, silicon, magnesium, and the like; a phosphate; or one surface-treated with a hydroxide or the like can be used as filler. The following methods can be used to form the filler layer: a method in which filler-containing slurry is directly applied to the positive electrode, the negative electrode, or the separator; a method in which a sheet formed from filler is attached to the positive electrode, the negative electrode, or the separator; and the like.

### INDUSTRIAL APPLICABILITY

A flat nonaqueous electrolyte secondary battery according to an aspect of the present invention can be used for applications where, for example, particularly high energy density is necessary for driving power supplies for mobile data terminals such as mobile phones, notebook personal computers, and tablet personal computers. Furthermore, expansion into high-power applications such as electric vehicles (EVs), hybrid electric vehicles (HEVs and PHEVs), and electric tools can be expected.

### REFERENCE SIGNS LIST

10 Laminate-type nonaqueous electrolyte secondary battery
11 Positive electrode tab
12 Negative electrode tab
13 Flat roll
14 Enclosure
15 Closed portion
16 Positive electrode plate
17 Negative electrode plate
18 Separators
21 Secondary particles
22 Primary particles
23 Cracks
24 Cracks

1. A flat nonaqueous electrolyte secondary battery comprising a positive electrode plate in which a positive electrode mix layer containing a positive electrode active material capable of reversibly storing and releasing lithium is formed, a negative electrode plate in which a negative electrode mix layer containing a negative electrode active material capable of reversibly storing and releasing lithium is formed, an electrode assembly having a structure in which the positive electrode plate and the negative electrode plate are stacked with a separator therebetween, and a nonaqueous electrolyte solution,
wherein a compound of at least one metal selected from Al, Mg, Ti, Zr, W, and rare-earth elements is attached to the surface of the positive electrode active material and a pressure is applied to the flat nonaqueous electrolyte secondary battery from outside in a direction in which the positive electrode plate, the negative electrode plate, and the separator are stacked.

2. The flat nonaqueous electrolyte secondary battery according to claim 1, wherein the packing density of the positive electrode mix layer is 2.2 g/cm³ to 3.4 g/cm³.

3. The flat nonaqueous electrolyte secondary battery according to claim 1, wherein the pressure is 9.81×10⁻³ MPa or more.

4. The flat nonaqueous electrolyte secondary battery according to claim 1, wherein the positive electrode active material contains secondary particles formed by aggregating a positive electrode active material made of a plurality of primary particles.

5. The flat nonaqueous electrolyte secondary battery according to claim 4, wherein the compound attached to the surface of the positive electrode active material is attached to at least the surface of the secondary particles of the positive electrode active material.

6. The flat nonaqueous electrolyte secondary battery according to claim 1, wherein the compound attached to the surface of the positive electrode active material contains a rare-earth element.

7. The flat nonaqueous electrolyte secondary battery according to claim 1, wherein the compound attached to the surface of the positive electrode active material is at least one selected from hydroxides, oxides, oxyhydroxides, carbonates, phosphates, and fluorine-containing compounds.

8. The flat nonaqueous electrolyte secondary battery according to claim 1, wherein the compound attached to the surface of the positive electrode active material is a hydroxide or oxyhydroxide of a rare-earth element.

9. A battery pack in which a plurality of flat nonaqueous electrolyte secondary batteries are connected in series, parallel, or series-parallel, the battery pack comprising:
a positive electrode plate in which a positive electrode mix layer containing a positive electrode active material capable of reversibly storing and releasing lithium is formed, a negative electrode plate in which a negative electrode mix layer containing a negative electrode active material capable of reversibly storing and releasing lithium is formed, an electrode assembly having a structure in which the positive electrode plate and the negative electrode plate are stacked with a separator therebetween, and a nonaqueous electrolyte solution,
wherein a compound of at least one metal selected from Al, Mg, Ti, Zr, W, and rare-earth elements is attached to the surface of the positive electrode active material; the flat nonaqueous electrolyte secondary batteries, which make up the battery pack, are arranged in a direction in which the positive electrode, the negative electrode, and the separator are stacked; the flat nonaqueous electrolyte secondary batteries are constrained to each other in the arrangement direction; and a confining pressure is applied to the flat nonaqueous electrolyte secondary batteries from outside in the direction in which the positive electrode, the negative electrode, and the separator are stacked.

10. The battery pack according to claim 9, wherein confining pressure is 9.81×10⁻³ MPa or more.
